(19) United States
(12) Patent Application Publication
(10) Pub. No.: US 2024/0416630 A1
(43) Pub. Date: Dec. 19, 2024

(54) LAMINATE MATERIAL WITH SUPERIOR BARRIER PERFORMANCE AND PREPARATION METHOD THEREOF

(71) Applicant: Dow Global Technologies LLC, Midland, MI (US)

(72) Inventors: Gang Wang, Shanghai (CN); ChenYan Bai, Shanghai (CN); Zhe Du, Shanghai (CN); Fanji Wang, Tokyo (JP); Xiaobing Yun, Shanghai (CN); Jianping Pan, Shanghai (CN); Jingyi Xu, Shanghai (CN); Jianliang Zhu, Shanghai (CN); Huan Qiu, Shanghai (CN)

(21) Appl. No.: 18/698,564

(22) PCT Filed: Nov. 8, 2021
(86) PCT No.: PCT/CN2021/129192

§ 371 Date: Apr. 4, 2024

(51) Int. Cl. B32B 27/08; B32B 7/12; B32B 27/32; B32B 37/12; C09J 175/06

(52) U.S. Cl. CPC B32B 27/08; B32B 7/12; B32B 27/32; B32B 37/12; C09J 175/06; B32B 2250/02; B32B 2250/242; B32B 2255/10; B32B 2255/205; B32B 2255/26; B32B 2255/28; B32B 2307/516; B32B 2307/518; B32B 2307/7244; B32B 2323/04; B32B 2375/00; B32B 2439/00; C09J 2475/00

(57) ABSTRACT

Provided are a laminate material, an article comprising the laminate material and a method for preparing the laminate material. The laminate material, comprises a first substrate comprising at least one metalized PE-based film, a second substrate comprising at least one PE-based film, and an adhesive layer adhering the first substrate to the second substrate, wherein the adhesive layer is derived from a two-component solvent-based polyurethane adhesive composition, and wherein the concentration of fatty acids or fatty acid derivatives in the metalized PE-based film is less than 300 ppm, based on the total weight of the metalized PE-based film. The two-component solvent-based polyurethane adhesive composition comprises a polyester polyol component and a polyisocyanate component, wherein the polyol component has 40 wt %-60 wt % of aromatic rings in the backbone, based on the total weight of the polyester polyol and a Mw between 5.000 and 50.000, and wherein the weight ratio of the polyester polyol component to polyisocyanate component is from 100:5 to 100:30.

### FIELD OF THE INVENTION

The present disclosure relates to a laminate material, an article comprising the laminate material and a method for preparing the laminate material. The laminate material exhibits superior barrier performance.

### BACKGROUND TECHNOLOGY

With the megatrend of recyclable economy, all polyethylene (PE) packages are more and more popular in industry. Barrier performance, e.g. oxygen transmission rate (OTR) and moisture vapor transmission (WVTR), are key attributes of various packages to provide crucial protection to the contents from an exterior circumstance to ensure a longer shelf life. However, due to the inherent inferior oxygen barrier of PE, it can be difficult to meet relevant high barrier needs using virgin PE design. Therefore, in the industry, there are various approaches to acquire the barrier performance, e.g. incorporating polymeric barrier resin through co-extrusion, vacuum metallization on a film substrate, or coating barrier materials on a film surface, etc. However, it is still a challenge in packaging industry to achieve high barrier performance of recyclable full PE structures in terms of OTR.

For the above reasons, there is still a need in the packaging industry to develop a recyclable all PE package with superior barrier performance.

After persistent exploration, the inventors have surprisingly developed an all PE laminate material with superior barrier performance which can be used in packages.

### SUMMARY

The present disclosure provides a unique laminate material exhibiting superior barrier performance, an article comprising the laminate material and a method for preparing the laminate material.

In a first aspect of the present disclosure, the present disclosure provides a laminate material, comprising
a first substrate comprising at least one metalized PE-based film;
a second substrate comprising at least one PE-based film,
an adhesive layer adhering the first substrate to the second substrate, wherein the adhesive layer is derived from a two-component solvent-based polyurethane adhesive composition; and
wherein the concentration of fatty acids or fatty acid derivatives in the metalized PE-based film is less than 300 ppm, based on the total weight of the metalized PE-based film,
wherein the two-component solvent-based polyurethane adhesive composition comprises a polyester polyol component and a polyisocyanate component,
wherein the polyester polyol component has 40 wt %-60 wt % of aromatic rings in the backbone, based on the total weight of the polyester polyol and a Mw between 5,000 and 50,000; and
wherein the weight ratio of the polyester polyol component to the polyisocyanate component is from 100:5 to 100:30.

In a second aspect of the present disclosure, the present disclosure provides an article comprising the laminate material of the present disclosure.

In a third aspect of the present disclosure, the present disclosure provides a method for preparing the laminate material, comprising
1) providing a first substrate comprising at least one metalized PE-based film and a second substrate comprising at least one PE-based film,
2) adhering the first substrate to the second substrate together by using a two-component solvent-based polyurethane adhesive composition;
wherein the concentration of fatty acids or fatty acid derivatives in the metalized PE-based film is less than 300 ppm, based on the total weight of the metalized PE-based film,
wherein the two-component solvent-based polyurethane adhesive composition comprises a polyester polyol component and a polyisocyanate component,
wherein the polyester polyol component has 40 wt %-60 wt % of aromatic rings in the backbone, based on the total weight of the polyester polyol and a Mw between 5,000 and 50,000; and
wherein the weight ratio of the polyester polyol component to the polyisocyanate component is from 100:5 to 100:30.

### DETAILED DESCRIPTION

Unless defined otherwise, all technical and scientific terms used herein have the same meaning as commonly understood by one of ordinary skill in the art to which the invention belongs. Also, all publications, patent applications, patents, and other references mentioned herein are incorporated by reference.

As disclosed herein, all ranges include endpoints unless otherwise indicated.

According to an embodiment of the present disclosure, the adhesive composition is a “two-component” or “two-part” composition comprising a polyester polyol component and a polyisocyanate component. According to another embodiment, the polyester polyol component and the polyisocyanate component are packaged, transported and stored separately, combined shortly or immediately before being used for the manufacture of the laminate material.

“Polyethylene”, “polyethylene polymer”, “polyethylene-based”, “PE-based” or “ethylene-based polymer” shall mean polymers comprising a majority amount (>50 mol %, or >60 mol %, or >70 mol % or >80 mol %, or >90 mol %, or >95 mol % or >97 mol %)) of units which have been derived from ethylene monomer. This includes polyethylene homopolymers or copolymers (meaning units derived from two or more comonomers). Common forms of polyethylene known in the art include Low Density Polyethylene (LDPE); Linear Low Density Polyethylene (LLDPE); Ultra Low Density Polyethylene (ULDPE); Very Low Density Polyethylene (VLDPE); single-site catalyzed Linear Low Density Polyethylene, including both linear and substantially linear low density resins (m-LLDPE); Medium Density Polyethylene (MDPE); and High Density Polyethylene (HDPE). These polyethylene materials are generally known in the art; however, the following descriptions may be helpful in understanding the differences between some of these different polyethylene resins.

The term “LDPE” may also be referred to as “high pressure ethylene polymer” or “highly branched polyethylene” and is defined to mean that the polymer is partly or entirely homo-polymerized or copolymerized in autoclave or tubular reactors at pressures above 14,500 psi (100 MPa) with the use of free-radical initiators, such as peroxides (see for example U.S. Pat. No. 4,599,392, which is hereby incorporated by reference). LDPE resins typically have a density in the range of 0.916 to 0.935 g/cm3.

The term “LLDPE”, includes both resin made using the traditional Ziegler-Natta catalyst systems and chromium-based catalyst systems as well as single-site catalysts, including, but not limited to, bis-metallocene catalysts (sometimes referred to as “m-LLDPE”) and constrained geometry catalysts, and includes linear, substantially linear or heterogeneous polyethylene copolymers or homopolymers. LLDPEs contain less long chain branching than LDPEs and includes the substantially linear ethylene polymers which are further defined in U.S. Pat. Nos. 5,272,236, 5,278,272, 5,582,923 and 5,733,155; the homogeneously branched linear ethylene polymer compositions such as those in U.S. Pat. No. 3,645,992; the heterogeneously branched ethylene polymers such as those prepared according to the process disclosed in U.S. Pat. No. 4,076,698; and/or blends thereof (such as those disclosed in U.S. Pat. No. 3,914,342 or U.S. Pat. No. 5,854,045). The LLDPEs can be made via gas-phase, solution-phase or slurry polymerization or any combination thereof, using any type of reactor or reactor configuration known in the art.

The term “MDPE” refers to polyethylenes having densities from 0.926 to 0.935 g/cm3. “MDPE” is typically made using chromium or Ziegler-Natta catalysts or using single-site catalysts including, but not limited to, bis-metallocene catalysts and constrained geometry catalysts, and typically have a molecular weight distribution (“MWD”) greater than 2.5.

The term “HDPE” refers to polyethylenes having densities greater than about 0.935 g/cm3 and up to about 0.970 g/cm³, which are generally prepared with Ziegler-Natta catalysts, chrome catalysts or single-site catalysts including, but not limited to, bis-metallocene catalysts and constrained geometry catalysts.

The term “ULDPE” refers to polyethylenes having densities of 0.880 to 0.912 g/cm3, which are generally prepared with Ziegler-Natta catalysts, chrome catalysts, or single-site catalysts including, but not limited to, bis-metallocene catalysts and constrained geometry catalysts.

“Polyolefin plastomer” can be a polyethylene plastomer or a polypropylene plastomer. Polyolefin plastomers include, for example, polymers made using single-site catalysts such as metallocenes and constrained geometry catalysts. Polyolefin plastomers have a density of 0.885 to 0.915 g/cm³. All individual values and subranges from 0.885 g/cm³ to 0.915 g/cm³ are included herein and disclosed herein; for example, the density of the polyolefin plastomer can be from a lower limit of 0.895, 0.900, or 0.905 g/cm³ to an upper limit of 0.905, 0.910, or 0.915 g/cm³. In some embodiments, the polyolefin plastomer has a density from 0.890 to 0.910 g/cm³.

“Polyolefin elastomer” can be a polyethylene elastomer or a polypropylene elastomer. The polyolefin elastomers have a density of 0.857 to 0.885 g/cm³. All individual values and subranges from 0.857 g/cm³ to 0.885 g/cm³ are included herein and disclosed herein; for example, the density of the polyolefin elastomer can be from a lower limit of 0.857, 0.860, 0.865, 0.870, or 0.875 g/cm³ to an upper limit of 0.870, 0.875, 0.880, or 0.885 g/cm³. In some embodiments, the polyolefin elastomer has a density from 0.860 to 0.880 g/cm³.

“polyethylene-based film” or “PE-based film” refers to a film that comprises at least 90 weight percent of polyethylene, at least 95 weight percent of polyethylene, at least 97 weight percent of polyethylene based on the total weight of the film.

### The First Substrate

The first substrate comprises at least one metalized PE-based film. The metalized PE-based film comprises a PE-based film and a metal layer.

The PE-based film in the metalized PE-based film has at least one layer comprising polyethylene. There can be one layer comprising polyethylene. Alternatively, there can be two or more layers comprising polyethylene. These two or more layers can be extruded together to form a PE-based film. There can be three (or three or more) layers comprising polyethylene. When there are three (or three or more) layers comprising polyethylene, the layer adjacent the metal layer is called herein a skin layer, the layer opposite the metal layer on the outside of the PE-based film is called a sealant layer, and a layer or layers between the skin and sealant layers is a core layer or core layers. When there is only one layer comprising polyethylene, any of the polyethylene compositions discussed herein as skin, core or sealant layers can be used. When there are only two layers comprising polyethylene, any combinations of skin layer and core layer, skin layer and sealant layer, or core layer and sealant layer can be used. When there are two or more polyethylene-comprising layers, each polyethylene-comprising layer can be immediately adjacent to at least one other polyethylene-comprising layer, or an adhesive layer or other intermediary layer can be used between the two or more polyethylene-comprising layers. In an embodiment, the PE-based film in the metalized PE-based film comprises a sealant layer. In an embodiment, the PE-based film in the metalized PE-based film comprises a skin layer, a core layer and a sealant layer.

The PE-based film in the metalized PE-based film can comprise a linear low density polyethylene (LLDPE), medium density polyethylene (MDPE), high density polyethylene (HDPE), a low density polyethylene (LDPE) as well as combinations of two or more of the foregoing. Preferably, the PE-based film in the metalized PE-based film can comprise a Ziegler-Natta catalyzed, single site catalyzed (including, without limitation, metallocene), or Chromium catalyzed linear low density polyethylene (LLDPE), medium density polyethylene (MDPE), high density polyethylene (HDPE), an autoclave produced or tubular produced low density polyethylene (LDPE) as well as combinations of two or more of the foregoing.

The PE-based film in the metalized PE-based film can further comprise at least one of an ultra-low density polyethylene, a polyoelfin plastomer, a polyolefin elastomer, an ethylene vinyl acetate copolymer, an ethylene ethyl acrylate copolymer, an ethylene vinyl alcohol, and any polymer comprising at least 50% ethylene monomer, and combinations thereof.

A skin layer can comprise a linear low density polyethylene (LLDPE), medium density polyethylene (MDPE), high density polyethylene (HDPE), a low density polyethylene (LDPE) as well as combinations of two or more of the foregoing; preferably can comprise a linear low density polyethylene (LLDPE), a low density polyethylene (LDPE) or combinations thereof. This LLDPE can be a single site catalyzed polyethylene (such as, and without limitation, m-LLDPE). The skin layer can further comprise additives, such as, for example, antioxidants, ultraviolet light stabilizers, thermal stabilizers, slip agents, antiblock, pigments or colorants, processing aids, crosslinking catalysts, flame retardants, fillers and foaming agents. When used in combination with a core layer or sealant layer, the skin layer is the layer that is metalized and in that instance is advantageously free of slip agents but may include anti-block agents (e.g. talc, silicon dioxide, etc.), anti-oxidants, and processing aids. In an embodiment, the additives such as slip agents and anti-block agents typically will not be used in the skin layer.

A core layer can comprise a linear low density polyethylene (LLDPE), medium density polyethylene (MDPE), high density polyethylene (HDPE), a low density polyethylene (LDPE) as well as combinations of two or more of the foregoing. The core layer can preferably comprise a middle density polyethylene (MDPE), a high density polyethylene (HDPE) or combinations thereof. The core layer can also comprise additives as mentioned for the skin layer. Preferably, additives such as slip agents and anti-block agents typically will not be used in the core layer. This layer can be adjacent the skin layer on an opposite side of the skin layer from the metal layer.

A sealant layer can comprise a linear low density polyethylene (LLDPE), medium density polyethylene (MDPE), high density polyethylene (HDPE), a low density polyethylene (LDPE), polyolefin elastomers or plastomers, as well as combinations of two or more of the foregoing. Preferably, the sealant layer can comprise a Ziegler-Natta catalyzed, single site catalyzed (including metallocene), or Chromium catalyzed linear low density polyethylene (LLDPE), medium density polyethylene (MDPE), high density polyethylene (HDPE), an autoclave produced or tubular produced low density polyethylene (LDPE) as well as combinations of two or more of the foregoing, preferably comprise a linear low density polyethylene (LLDPE), a low density polyethylene (LDPE) or combinations thereof. The LLDPE can be a single site catalyzed polyethylene (e.g. mLLDPE). This can be an outer layer of the film. The sealant layer may advantageously include an anti-blocking agent. For example, an anti-block agent may be present in the sealant layer at an amount of at least about 200 ppm, at least about 1000 ppm or at least about 1500 ppm, preferably not greater than about 6000 ppm, or not greater than about 5000 ppm. In addition, slip agents (e.g. erucamide) may be helpful. For example, slip agents may be present in the sealant layer at an amount of less than 500 ppm, or less than 300 ppm, or less than 200 ppm, less than 100 ppm, preferably less than 50 ppm, or equal to 0 ppm, based on total weight of the sealant layer.

The PE-based film of the metalized PE-based film can be a blown film, a cast film, a machine direction oriented film or a biaxially oriented film. The PE-based film of the metalized PE-based film layer can be fabricated through blown, casting, water quenching, double bubble, or other techniques known to those of ordinary skill in the art such as those described in Film Processing Advances, Toshitaka Kanai and Gregory A. Campbell (editors), Chapter 7 (Biaxial Oriented Film Technology), pp. 194-229. In some embodiments, after fabrication, the film may be subjected to machine direction orientation (MDO) or biaxial orientation process to provide a machine direction oriented film or a biaxially oriented film, respectively.

The PE-based film of the metalized PE-based film layer can be metallized by any known method for metallizing polyethylene films. For example, the metal layer can be applied using vacuum metallization. This can include providing a metal source and evaporating it in a vacuum environment causing it to condense on the surface of the film. The metal is deposited on the skin layer of the PE-based film.

Suitable metals include Al, Zn, Au, Ag, Cu, Ni, Cr, Ge, Se, Ti, Sn, or oxides thereof. The metal layer can be formed from aluminum or aluminum oxide (Al₂O₃) in some embodiments.

After metallization, the metallized PE-based film can conveniently be stored in rolls. In this process, the metallized surface layer is in contact with a polyethylene layer on the opposite side of the film.

The overall thickness of the metalized film can be at least 10, at least 20, or at least 30 microns. The overall thickness of the metallized film according to certain embodiments is no more than 200, no more than 150, no more than 120, no more than 100, no more than 80, no more than 70, or no more than 60 microns.

The metallized PE-based film can have an optical density (OD) at least 1.5, or at least 1.8 and no more than 4.0, no more than 3.5, or no more than 3.0. In some embodiments, the OD is 2.0. The optical density of a metallized PE-based film (e.g., a multilayer structure comprising a polyethylene film with a metal layer deposited on it) can be measured using an optical density meter (Model No. LS177 from Shenzhen Linshang Technology).

The metallized PE-based film can retain a surface energy of the metallized surface of at least 34 dyne/cm, at least 38 dyne/cm, at least 40 dyne/cm, or at least 42 dyne/cm, or at least 46 dyne/cm for at least one or at least two weeks from the metallization.

The metalized PE-based film can be characterized by the absence (0 ppm) or substantial absence of fatty acids or its derivatives. Such fatty acids or its derivatives that are absent or substantially absent include saturated fatty acid with an even number of carbon atoms, from 4 to 28, such as stearic acid (18 carbon atoms) and palmitic acid (16 carbon atoms), etc., and the metal salts of the respective fatty acid, such as calcium stearate, zinc stearate, calcium palmitate, etc. Specifically, the concentration of fatty acids or its derivatives in the metalized PE-based film can be no more than 300 ppm, no more than 250 ppm, no more than 200 ppm, no more than 100 ppm, or no more than 50 ppm, or equal to 0 ppm, based on total weight of the metalized PE-based film.

The concentration of anti-oxidants in the metalized PE-based film layer is less than 3000 ppm, or less than 2000 ppm, or less than 1500 ppm, or less than 1300 ppm, based on the total weight of the metallized PE-based film.

### Additives

An anti-oxidant is a compound included in polymeric films to stabilize the polymer(s) or prevent oxidative degradation of the polymer(s). Anti-oxidants are well known to persons of ordinary skill in the art.

An antiblock agent is a compound that minimizes, or prevents, blocking (i.e., adhesion) between two adjacent layers of film. Blocking can cause issues, for example, during unwinding of a film roll. The use of antiblock agents is well known to persons of ordinary skill in the art. Examples of common antiblock agents include, without limitation, silica, talc, calcium carbonate, and combinations thereof.

A slip agent is a compound added to a film to reduce friction between films and/or between films and equipment. Typical slip agents include migratory and non-migratory slip agents and are well to persons of ordinary skill in the art.

### The Adhesive Layer

The adhesive layer is derived from a two-component solvent-based polyurethane adhesive composition, wherein the two-component solvent-based polyurethane adhesive composition comprises a polyester polyol component and a polyisocyanate component.

### A. The Polyester Polyol Component

The polyester polyol is typically obtained by reacting polyfunctional alcohols having from 2 to 12 carbon atoms, preferably from 2 to 10 carbon atoms, with polyfunctional carboxylic acids having from 2 to 12 carbon atoms, preferably 2 to 10 carbon atoms, or anhydrides/esters thereof. Typical polyfunctional alcohols for preparing the polyester polyol are preferably diols, triols, tetraols, and may include ethylene glycol, butylene glycol, diethylene glycol, triethylene glycol, polyalkylene glycols, 1,2-propanediol, 1,3-propanediol, 1,3-butanediol, 1,4-butanediol, 1,6-hexanediol, neopentyl glycol, trimethylolpropane, glycerol, erythritol, pentaerythritol, trimethylolbenzene, and any combinations thereof. Typical polyfunctional carboxylic acids for preparing the polyester polyol can be aliphatic, cycloaliphatic, araliphatic, aromatic or heterocyclic and may be substituted, for example with halogen atoms, and/or may be saturated or unsaturated. Preferably, the polyfunctional carboxylic acids are selected from the group consisting of adipic acid, suberic acid, azelaic acid, sebacic acid, phthalic acid, isophthalic acid, glutaric acid, tetrachlorophthalic acid, maleic acid, fumaric acid, itaconic acid, malonic acid, 2-methyl succinic acid, 3,3-diethyl glutaric acid, 2,2-dimethyl succinic acid, trimellitic acid, the anhydrides thereof, and any combinations thereof. Preference is given to adipic acid or a mixture of adipic acid and isophthalic acid. In another embodiment, the polyester polyol has an OH number of 2 to 30 mg KOH/g, preferably from 5 to 25 mg KOH/g, and more preferably from 8 to 20 mg KOH/g.

According to an embodiment of the present disclosure, the polyester polyol has a hydroxyl functionality of at least 1.8, or at least 1.9, or at least 2.0, or at least 2.1, or at least 2.2, or up to 2.3, or up to 2.4, or up to 2.5, or up to 2.6, or up to 2.7, or up to 2.8, or up to 2.9, or up to 3.0, or within a numerical range obtained by combining any two of the above indicated end points. The polyester polyol may have a molecular weight from 5000 to 50,000 g/mol, or from 5500 to 30,000 g/mol, or from 6,000 to 25,000 g/mol, or from 10,000 to 15,000 g/mol, or within a numerical range obtained by combining any two of the above indicated end points. The above introduction about the origin, preparation process, category, molecular structure and various parameters of polyester polyol also apply to this second polyester polyol.

According to an embodiment of the present disclosure, the polyester polyol has an aromatic ring content of from about 40 wt % to about 60 wt % or from about 45 wt % to about 55 wt % or from about 47 wt % to about 55 wt %, based on the dry weight of the polyester polyol.

For example, as one illustrative embodiment, the content of the polyester polyol can be from 40 wt % to 85 wt %, or from 50 wt % to 80 wt %, or from 60 wt % to 77 wt %, or from 65 wt % to 75 wt %, based on the total weight of the polyurethane adhesive composition.

The solid content of polyester polyol component can be 40-85 wt %, preferably 50-80 wt %, more preferably 55-75%, and the solvent used for the polyester polyol could be ethyl acetate or MEK, or combination, preferably ethyl acetate.

### B. The Polyisocyanate Component

The polyisocyanate may include any molecules having 2 or more isocyanate groups, and mixtures thereof. Such polyisocyanates can be aliphatic, alicyclic, aromatic, araliphatic or mixtures thereof. The polyisocyanates may have an average functionality of >2 or from 2.5 to 10. Examples of suitable polyisocyanates include C₂-C₁₂ aliphatic diisocyanates, as well as dimers and trimers thereof, such as, for example, C₂-C₈ alkylene diisocyanates, such as tetramethylene diisocyanate and hexamethylene diisocyanate (HDI), 1,12-dodecane diisocyanate, 2,2,4-trimethyl-hexamethylene diisocyanate, 2,4,4-trimethyl-hexamethylene diisocyanate, 2-methyl-1,5-pentamethylene diisocyanate; C₆-C₁₅ alicyclic diisocyanates, as well as dimers and trimers thereof, such as, for example, isophorone diisocyanate (IPDI) and dicyclohexyl methane diisocyanate (HMDI), 1,4-cyclohexane diisocyanate, and 1,3-bis-(isocyanatomethyl)cyclohexane; C₆-C₁₂ aromatic diisocyanates, as well as dimers and trimers thereof, such as, for example, toluene diisocyanate (TDI), and diphenyl methane diisocyanate (MDI); C₇-C₁₅ araliphatic diisocyanates as well as dimers and trimers thereof, such as, for example,

Preferably, the polyisocyanate comprises aliphatic or aromatic polyisocyanates. More preferably, the polyisocyanates are hexamethylene diisocyanate homopolymers, hexamethylene diisocyanate adducts, isophorone diisocyanate homopolymers, isophorone diisocyanate adducts, toluene diisocyanate (TDI), toluene diisocyanate (TDI) adducts, diphenyl methane diisocyanate (MDI), diphenyl methane diisocyanate (MDI) adducts, or mixtures thereof. The trimers (or isocyanurates) in the polyisocyanate may be prepared by methods known in the art, for example, as disclosed in U.S. Patent Publication No. 2006/0155095A1, to Daussin et al., by trimerizing an alicyclic diisocyanate (e.g. isophorone diisocyanate) in the presence of one or more trimerization catalyst, such as, for example, a tertiary amine or phosphine or a heterogeneous catalyst, and, if desired, in the presence of solvents and/or assistants, such as co-catalysts, expediently at elevated temperature, until the desired isocyanate (NCO) content has been reached, and then deactivating the catalyst using inorganic and organic acids, the corresponding acid-halides and alkylating agents and, preferably, heating. Isocyanurate compositions containing isocyanurates from aliphatic diisocyanates may likewise be formed by cyclizing aliphatic diisocyanates in the presence of one or more trimerization catalyst and then deactivating the catalyst. Any of the isocyanurates can be further modified by conventional methods to contain urethane, urea, imino-s-triazine, uretonimine or carbodiimide moieties. Preferably, the polyisocyanate useful in the present invention is selected from the group consisting of an aromatic diisocyanate, dimers and trimers thereof, or mixtures thereof.

The polyisocyanate useful in the present invention may include one or more polyisocyanate prepolymers, which may be formed by reaction of a diisocyanate with a monol, diol, diamine, or monoamine, which is then modified by the reaction of additional isocyanate to form allophanate or biuret modified prepolymers. Such prepolymers may further comprise a polyalkoxy or polyether chain. Alternatively, such prepolymers can then be mixed with a trimerization catalyst giving an allophanate or biuret modified polyisocyanate compositions. Preparation of such allophanate or biuret prepolymers, followed by trimerization, is known in the art, see for example, U.S. Pat. Nos. 5,663,272 and 6,028,158. Still further, suitable polyisocyanates may be modified by an ionic compound such as aminosulfonic acid.

Commercially available polyisocyanates may include, for example, Desmodur L75, N3300, N3600, and N3900 polyisocyanates and Bayhydur XP 2655, 401-60 and 401-70 polyisocyanates (Covestro); Tolonate HDT, HDT-LV and HDT-LV2, and Easaqua L 600 polyisocyanates (Vencorex Chemicals); DURANATE TLA-100 and TMA-100 polyisocyanates (AsahiKASEI); and Aquolin 268, 269 and 270 polyisocyanates (Wanhua Chemicals).

The polyisocyanate useful in the present invention can be used alone or diluted with one or more solvents to form a polyisocyanate solution, prior to mixing with the polyol component. Such solvents (also as “diluting solvents”) can reduce the viscosity of the polyisocyanate and have no reactivity with the polyisocyanate. The solvent may be used in an amount of from 5% to 150%, from 15% to 130%, from 20% to 120%, or from 30% to 100%, by weight based on the weight of the polyisocyanate. Suitable diluting solvents may include, for example, ethyl acetate, butyl acetate, MEK, or mixtures thereof. The solid content of the polyisocyanate component can be 40-100 wt %, preferably 50-90 wt %, more preferably 55-80%. The polyurethane adhesive composition of the present invention may have equivalent ratios of the total number of isocyanate group equivalents in the polyisocyanates, which may contain several different polyisocyanates, to the total number of hydroxyl group equivalents in the polyester polyol component, in the range of, for example, from 1:1 to 2.0:1, or from 1:1 to 1.8:1, or from 1:1 to 1.5:1 or 1:1 to 1.2:1. According to a preferable embodiment of the present disclosure, the amount of the polyisocyanate compound is properly selected so that the isocyanate group is present at a stoichiometric molar amount relative to the total molar amount of the hydroxyl groups included in the polyester polyol component.

The polyurethane adhesive composition of the present invention may further comprise conventional additives such as, for example, catalysts to enhance curing, pigments, light stabilizers, ultraviolet (UV) absorbing compounds, leveling agents, wetting agents, dispersants, neutralizers, defoamers, or rheology modifiers, or mixtures thereof. These additives may be present in an amount of from zero to 20%, from 1 to 10%, by weight based on the weight of the polyurethane composition.

According to an embodiment of the present disclosure, the weight ratio of the polyester polyol component to the polyisocyanate component is from about 100:5 to about 100:30, preferably from about 100:8 to about 100:25, more preferably from about 100:10 to about 100:20.

The polyurethane adhesive can be prepared by mixing polyester polyol component and polyisocyanate component together to mix them homogeneously and adding a certain amount of solvent to achieve a desired solid content.

### The Second Substrate

The second substrate can in general be any PE-based film.

The PE-based film in the second substrate can comprise a linear low density polyethylene (LLDPE), medium density polyethylene (MDPE), high density polyethylene (HDPE), a low density polyethylene (LDPE) as well as combinations of two or more of the foregoing. Preferably, the PE-based film in the second substrate can comprise a Ziegler-Natta catalyzed, single site catalyzed (including metallocene), or Chromium catalyzed linear low density polyethylene (LLDPE), medium density polyethylene (MDPE), high density polyethylene (HDPE), an autoclave produced or tubular produced low density polyethylene (LDPE) as well as combinations of two or more of the foregoing.

The PE-based film in the second substrate can further compromise at least one of an ultra-low density polyethylene, a polyolefin plastomer, a polyolefin elastomer, an ethylene vinyl acetate copolymer, an ethylene ethyl acrylate copolymer, an ethylene vinyl alcohol, and any polymer comprising at least 50% ethylene monomer, and combinations thereof.

The PE-based film in the second substrate can be a blown film, a cast film, a machine direction oriented film or a biaxially oriented film. The PE-based film in the second substrate can be fabricated through blown, casting, water quenching, double bubble, or other techniques known to those of ordinary skill in the art such as those described in Film Processing Advances, Toshitaka Kanai and Gregory A. Campbell (editors), Chapter 7 (Biaxial Oriented Film Technology), pp. 194-229. In some embodiments, after fabrication, the film may be subjected to machine direction orientation (MDO) or biaxial orientation process to provide a machine direction oriented film or a biaxially oriented film, respectively.

The PE-based film in the second substrate can comprises 1-10 layers, or 1-8 layers or 1-5 layers.

### The Laminate Material

The laminate material can be prepared by a method comprising the following steps:
1) providing a first substrate comprising at least one metalized PE-based film (as described above) and a second substrate comprising at least one PE-based film (as described above),
2) adhering the first substrate to the second substrate together by using a two-component solvent-based polyurethane adhesive composition;
wherein the concentration of fatty acids or fatty acid derivatives in the metalized PE-based film is less than 300 ppm, based on the total weight of the metalized PE-based film,
wherein the two-component solvent-based polyurethane adhesive composition comprises a polyester polyol component and a polyisocyanate component,
wherein the polyester polyol component has about 40 wt %-60 wt % of aromatic rings in the backbone, based on the total weight of the polyester polyol and a Mw between about 5,000 and about 50,000; and
wherein the weight ratio of the polyester polyol component to the polyisocyanate component is from about 100:5 to about 100:30.

The content of PE in the laminate material is greater than 90 wt %, or greater than 92 wt %, greater than 93 wt %, greater than 95 wt %, greater than 98 wt %, based on the total weight of the laminate material.

The laminate of the present disclosure has an OTR of lower than 2.3 cc/m²*24 hours measured under the condition of 23° C. and 0% relative humidity when measured using the Test Method described herein, or less than 2.0 cc/m²*24 hours or less than 1.9 cc/m²*24 hours or not greater than 1.8 cc/m²*24 hours when measured using the Test Method described herein.

The laminate material can be used to form articles such as packages. Examples of packages that can be formed from the laminate material of the present invention can include flexible packages, pouches, stand-up pouches, and pre-made packages or pouches. The laminate material of the present invention can be used for food packages. Examples of food that can be included in such packages include meats, cheeses, cereal, nuts, juices, sauces, and others. Such packages can be formed using techniques known to those of skill in the art based on the teachings herein and based on the particular use for the package (e.g., type of food, amount of food, etc.).

### EXAMPLES

Some embodiments of the invention will now be described in the following Examples. However, the scope of the present disclosure is not, of course, limited to the formulations set forth in these examples. Rather, the Examples are merely inventive of the disclosure.

The information of the raw materials used in the examples is listed in the following Table 1:

TABLE 1
Raw materials used in the examples

| | Code | Composition | Remark | Supplier |
|---|---|---|---|---|
| Adhesive | ADCOTE ™ 516A | NCO prepolymer, | Solvent- | The Dow |
| | | 70%, solid content | based | Chemical |
| | | | (SB) | Company |
| | ADCOTE ™ 516B | Polyol coreactant, | adhesive | The Dow |
| | | 70%, solid content | | Chemical |
| | | | | Company |
| | IE-PES-1(47% IPA/16% | Polyester polyol, | | Prepared in |
| | AdA/7% EG/30% DEG)* | aromatic ring = 47% | | the |
| | | Mw = 14288, | | Example |
| | | 66%, solid content | | Section |
| | IE-PES-2(47% IPA/15% | Polyester polyol, 47% | | Prepared in |
| | AdA/8% EG/31% DEG)* | aromatic ring, | | the |
| | | Mw = 22578 | | Example |
| | | 60%, solid content | | Section |
| | IE-PES-3 | Polyester polyol, | | Prepared in |
| | (55% IPA/10% AdA/8% | aromatic ring = 55% | | the |
| | EG/27% DEG/1% TMP)* | Mw = 6231 | | Example |
| | | 80%, solid content | | Section |
| | CE-PES-1(54% | Polyester polyol, | | Prepared in |
| | IPA/15% SA/12% | aromatic ring = 54%, | | the |
| | EG/19% DEG)* | Mw = 60916, | | Example |
| | | 51%, solid content | | Section |
| | CE-PES-2 | Polyester polyol, | | Prepared in |
| | (29% IPA/29% SA/2% EG/ | aromatic ring = 29%, | | the |
| | 34% NPG)* | Mw = 13280 | | Example |
| | | 66%, solid content | | Section |
| | Coreactant F | Polyisocyanate | | The Dow |
| | | crosslinker based on | | Chemical |
| | | TDI, 75%, solid | | Company |
| | | content | | |
| | R-600 | Polyurethane | WB | DSM Co. |
| | | dispersion | adhesive | Ltd |
| | MOR-FREE ™ 698A | NCO prepolymer | SL | The Dow |
| | | | adhesive | Chemical |
| | | | | Company |
| | MOR-FREE ™ C83 | Polyol coreactant | | The Dow |
| | | | | Chemical |
| | | | | Company |
| PE | ELITE ™ AT6410 | MI = 0.85, | LLDPE | The Dow |
| products | | Density = 0.912 | | Chemical |
| | | | | Company |
| | ELITE ™ AT6900 | MI = 1.2, | HDPE | The Dow |
| | | Density = 0.969 | | Chemical |
| | | | | Company |
| | UNIVAL ™ DMDA6400 | MI = 0.8, | HDPE | The Dow |
| | | Density = 0.961 | | Chemical |
| | | | | Company |
| | DOW LDPE 450E | MI = 2.0, | LDPE | The Dow |
| | | Density = 0.923 | | Chemical |
| | | | | Company |
| Anti- | AB20 masterbatch | MI = 1.9, | | BEIJING |
| block | | Density 0.925 | | YALUNZ |
| agent | | | | HILIAN |
| | | | | SCIENCE |
| | | | | &TECHNOLOGY |
| | | | | CO,. LTD |

*IPA represents isophthalic acid; PA represents phthalic acid; AdA represents adipic acid, EG represents ethylene glycol, DEG represents diethylene glycol, SA represents sebacic acid, NPG representsneopentyl glycol.

All the PE-based films were fabricated through blown process. Formulations are listed in Table 2. Film-1 and Film-2 had a thickness of 50 μm. The vacuum metallization was conducted on an industrial metallization machine (Machine type K5 EXPERT, BOBST Company) with OD=2.0. MET-1 and MET-2 is the symbol indicating the metallized Film-1 and Film-2, respectively. Before adhesive lamination, the vacuum-metallized Films fabricated were stored in manner of film rolls for 2 weeks under an environment of 23° C. and 50% humidity. The surface energy of metal layer of Metalized film-1 (MET-1) declined to <34 Dyne and the surface energy of metal layer of Metalized film-2 (MET-2) is still >46 Dyne/cm. Thereafter, the adhesive lamination was conducted on Labo-Combi 400 machine from Nordmeccanica.

TABLE 2
Formulation of PE-based films for vacuum metallization

| | | | | Sample |
|---|---|---|---|---|
| | | | | name of |
| | | | | metalized |
| PE-based | | | | PE-based |
| film name | Skin Layer | Core Layer | Sealant Layer | films |
| Layer ratio | 1 | 2 | 1 | |
| by thickness | | | | |
| Film-1 | 90% ELITE ™ | ELITE ™ | 88% ELITE ™ | MET-1 |
| | AT6410 + 10% | AT6900 | AT6410 + 10% LDPE + | |
| | LDPE 450E | | 2% AB20L | |
| Additive | — | — | Anti-block in the | |
| concentrations | | | sealant layer: 4000 | |
| (ppm) | | | slip agent in the | |
| | | | sealant layer: 0 | |
| | overall anti-oxidant in the film: 2000; overall | | | |
| | fatty acid or its derivatives in the film: 350 | | | |
| Film-2 | 90% ELITE ™ | UNIVAL ™ | 88% ELITE ™ | MET-2 |
| | AT6410 + 10% | DMDA6400 | AT6410 + 10% LDPE + | |
| | LDPE 450E | | 2% AB20L | |
| Additive | — | — | Anti-block in the | |
| concentrations | | | sealant layer: 4000 | |
| (ppm) | | | slip agent in the | |
| | | | sealant layer: 0 | |

overall anti-oxidant in the film: 1200; overall
fatty acid or its derivatives in the film: 0

The BOPE films used in the inventive structures are model Lightweight PE films (DL) having a thickness of 25 microns (after orientation), commercially available from Guangdong Decro Film New Materials CO. Ltd. The film is a biaxially oriented, and the polyethylene composition used in the BOPE films is INNATE™ TF80 resin from the Dow Chemical Company.

The MDOPE film is a 5-layer coextruded structure having a thickness of 25 um after orientation. All polyethylene resins used are from The Dow Chemical Company as showed in below table 3. POLYBATCH AO 25, an antioxidant masterbatch, is commercially available from A. Schulman and POLYBATCH AMF 705 HF, a slip and anti-block masterbatch, is available from A. Schulman.

TABLE 3
5 layers of the MDOPE film

| Layer | A | D | C | B | E |
|---|---|---|---|---|---|
| Thickness (um) | 6.25 | 6.25 | 6.25 | 4.17 | 2.08 |
| ELITE ™ 5960G* | 97% | | | | |
| ELITE ™5940ST* | | 99% | 79% | 99.0% | |
| ELITE ™5400G* | | | 20% | | |
| AFFINITY ™ PL1880G* | | | | | 20% |
| AFFINITY ™ EG8100G* | | | | | 77% |
| POLYBATCH ® AO 25 | 1% | 1% | 1% | 1% | 1% |
| POLYBATCH ® AMF 705 HF* | 2% | | | | 2% |

*wt %, based on the total weight of the indicated layer

### Standard Process to Prepare Inventive Example Polyesters (IE-PES) and Comparative Example Polyesters (CE-PES):

Charge all raw materials (such as IPA, AdA, EG and DEG) into reactor and heat to 100° C., and hold at this temperature for 30 minutes, then heat to 175° C. and hold for another 45 minutes, then increase temperature to 225° C. and hold until acid value below 25 mg KOH/g. Then apply vacuum (ca 500 mmHg) and hold for 15-30 minutes. Then maintain temperature and decrease vacuum to ca. 200 mmHg gradually. When acid value is below 10 mgKOH/g, decrease vacuum to ca 50 mmHg, when acid value is below 2 mgKOH/g, then decrease vacuum to ca 10 mmHg, then start to cool to 160° C. and break vacuum with N₂, when temperature is below 160° C., then start to add ethyl acetate to achieve desired solid content, continue to cool to 70° C. and pack out.

### Preparation of the Polyurethane Adhesive Composition

The solvent-borne (SB) adhesive was prepared according to below procedure: weigh a certain amount of polyester polyol and coreactant F and mix them together according to the designed mixing ratio, then start to agitate and add calculated amount of ethyl acetate to achieve 30% solid content, and continue to agitate to make sure adhesive is homogeneous. The prepared SB adhesive was conducted lamination process on Labo-Combi 400 machine from Nordmeccanica and make sure the dry coating weight was between 3.0-3.5 gsm.

Solventless (SL) adhesive: weigh a certain amount of NCO prepolymer and polyol coreactant and mix them together to get a homogenous adhesive, then pour the adhesive into coating roller on Labo-Combi 400 machine from Nordmeccanica to conduct lamination and make sure dry coating weight is 1.8-2.0 gsm coating weight.

Water-borne (WB) adhesive: WB adhesive was conducted lamination directly on Labo-Combi 400 machine from Nordmeccanica to make sure dry coating weight was between 2.0-2.5 gsm.

TABLE 4
Full PE package solutions

| | Structure | Adhesive information | OTR (cc/m2*day, |
|---|---|---|---|
| | information | (weight ratio) | 23° C., 0% RH) |
| IEx. 1 | BOPE/SB | IE-PES-1/F = 100:11 | 1.8 |
| IEx. 2 | adhesive/MET-2 | IE-PES-1/F = 100:20 | 1.3 |
| IEx. 3 | | IE-PES-3/F = 100:14 | 1.7 |
| IEx. 4 | | IE-PES-2/F = 100:10 | 1.4 |
| CEx. 1 | BOPE/SB | Adcote ™ | 5.7 |
| | adhesive/MET-2 | 516A/B = 100:35 | |
| CEx. 2 | | CE-PES-1/F = 100:6.5 | 2.9 |
| CEx. 3 | | CE-PES-1/F = 100:12 | 2.3 |
| CEx. 4 | | CE-PES-2/F = 100:12 | 4.2 |
| CEx. 5 | BOPE/SL | MorFree ™ | 6.8 |
| | adhesive/MET-2 | 698A/C83 = 100:50 | |
| CEx. 6 | BOPE/WB | R-600 | 26 |
| | adhesive/MET-2 | | |
| CEx. 7 | BOPE/SB | IE-PES-1/F = 100:11 | 5.10 |
| | adhesive/MET-1 | | |
| CEx. 8 | MET-2 | No lamination | 47.3 |
| CEx. 9 | MET-1 | No lamination | 41.3 |
| IEx. 5 | MDOPE/SB | IE-PES-1/F = 100:11 | 1.5 |
| | adhesive/MET-2 | | |
| IEx. 6 | Film-2/SB | IE-PES-1/F = 100:11 | 1.6 |
| | adhesive/MET-2 | | |
| CEx. 10 | BOPE/SB | IE-PES-1/F = 100:11 | 774 |
| | adhesive/Film-2 | | |
| CEx. 11 | BOPE | No lamination | >1000 |

IEx.1-4 used inventive two component SB (solvent-based) PU adhesive and inventive metalized PE-based film (MET-2), and they showed good OTR results.

CEx.1 used the same inventive metalized PE-based film (MET-2) but a two component SB PU adhesive which used a polyether polyol backbone, rather than a polyester polyol backbone, and its OTR was not as good as the inventive examples;

CEx.2-4 used the same inventive metalized PE-based film (MET-2) and a two component SB PU adhesive, which was polyester polyol based but had either lower aromatic ring backbone or too high Mw, which were out of the scope of the present invention, and they showed poor OTR vs the inventive examples;

CEx.5 and CEx.6 used the same inventive metalized PE-based film (MET-2) but a two component SL or WB adhesive, not the inventive adhesive, and they showed poor OTR results.

CEx7 used the inventive adhesive, but different metalized PE film (MET-1), and showed poor OTR results;

CEx8 and CEx.9 were pure metalized PE film, without lamination by an adhesive, showed quite high OTR results vs the inventive examples, which indicated that both metallization and adhesive are crucial to achieve good OTR.

IEx5 and IEx6 used the inventive adhesive and metalized PE-based film (MET-2), and laminated with other the skin films, like MDOPE or normal PE film, also showed good OTR results;

CEx10 used inventive adhesive, but without metallization for inner layer, showed very poor OTR, which indicated that both adhesive and metallization are crucial to achieve good OTR.

### Test Method

### Oxygen Transmission Rate (OTR)

The oxygen transmission rate was measured in accordance with ASTM D-3985 using a MOCON OX-TRAN Model 2/21 measurement device at a temperature of 23° C. at a relative humidity of 0% using purified oxygen. When the barrier data of sample was over 200 cc/m²-day, mask was applied for reducing the testing area from 50 cm² to 5 cm² to acquire data in larger testing range.

### Optical Density (OD) Test

OD testing was done with a spectrophotometer (Type LS117, Shenzhen Linshang Technology Co., Ltd). The metallized film was positioned between the optical emitter and receptor, with metallized surface facing the emitter. OD was read and recorded.

### Surface Energy Test

The test was based on the usage of ACCU DYNE TEST™ marker pens, which was based on a valve tip applicator. The principle was to keep the testing part of the pen away from the fluid storage part of the pen.

The dyne level testing procedure using the pens was as below:

Place a piece of metallized film sample on flat glass plate;

Record ambient temperature and relative humidity. If sample temperature differs from ambient, allow it to stabilize.

Test at least three points across the sample; ¼, ½, and ¾ across the film section

### Determination of Wetting

1. Choose a marker pen of a dyne level you believe is slightly lower than that of the test sample.
2. Press applicator tip firmly down on subject material until the tip is saturated with ink.
3. Use a light touch to draw the pen across the test sample in two or three parallel passes. Disregard the first pass(es); to flush any contamination from the tip, and to ensure that the test fluid layer is thin enough for accurate measurement, evaluate only the last pass.
4. If the last ink swath remains wetted out on the test sample for three seconds or more, repeat steps 2 and 3 with the next higher dyne level marker. If the last ink swath beads up, tears apart, or shrinks into a thin line within one second or less, repeat steps 2 and 3 with the next lower dyne level marker.
5. If the ink swath holds for one to three seconds before losing its integrity, the dyne level of the marker closely matches that of the sample. And the value of corresponding pen is recorded.

### Determination of the Fatty Acid Content

The fatty acid content was analyzed by extracting the additive from films using CH₂CI₂, followed by filtration and analyzing with LC-MS (Liquid chromatography-mass spectrometry). Standard solutions were made in appropriate concentration range of fatty acid.

### Determination of the Anti-Block Agent Content

The anti-block agent was analyzed by thermal gravimetric (TGA) analysis. TGA was conducted on a TA Q500 instrument. Film samples were tested under a N₂ environment. The test protocol was:
Heat from 25 to 800° C. at 10° C./min
Isothermal at 800° C. for 3 min

The residue weight was recorded as the anti-block additive amount.

### Determination of the Slip Agent Content and Anti-Oxidant Content

The slip agent and anti-oxidant content was analyzed by total dissolution method. The film sample was dissolved by 0.075% triethyl phosphite in o-xylene at 130° C. The solution is let cooled and methanol added followed by stirring. After the solid settled, the solution was injected into liquid chromatography (LC) autosampler for antioxidant analysis and gas chromatography (GC) for slip additive analysis.

1. A laminate material, comprising
a first substrate comprising at least one metalized PE-based film;
a second substrate comprising at least one PE-based film; and
an adhesive layer adhering the first substrate to the second substrate, wherein the adhesive layer is derived from a two-component solvent-based polyurethane adhesive composition;
wherein the concentration of fatty acids or fatty acid derivatives in the metalized PE-based film is less than 300 ppm, based on the total weight of the metalized PE-based film,
wherein the two-component solvent-based polyurethane adhesive composition comprises a polyester polyol component and a polyisocyanate component,
wherein the polyester polyol component has about 40 wt %-60 wt % of aromatic rings in the backbone, based on the total weight of the polyester polyol and a Mw between 5,000 and 50,000; and
wherein the weight ratio of the polyester polyol component to the polyisocyanate component is from 100:5 to 100:30.

2. The laminate material of claim 1, wherein the weight ratio of the polyester polyol component to the polyisocyanate component is from 100:10 to 100:20.

3. The laminate material of claim 1, the metalized PE-based film comprises a PE-based film and a metal layer.

4. The laminate material of claim 1, wherein the PE-based film in the metalized PE-based film comprises a skin layer, a core layer and a sealant layer.

5. The laminate material of claim 4, wherein anti-block agents are present in the sealant layer at an amount of at least 200 ppm, based on total weight of the sealant layer.

6. The laminate material of claim 4, wherein slip agents are present in the sealant layer at an amount of less than 500 ppm, based on total weight of the sealant layer.

7. The laminate material of claim 1, wherein the metallized PE-based film has an optical density (OD) of at least 1.5 and no more than 4.0.

8. The laminate material of claim 1, wherein the concentration of anti-oxidants in the metalized PE-based film layer is less than 3000 ppm, based on the total weight of the metallized PE-based film.

9. The laminate material of claim 1, wherein the PE-based film of the metalized PE-based film layer is a blown film, a cast film, a machine direction oriented film, or a biaxially oriented film.

10. The laminate material of claim 3, the metal layer includes Al, Zn, Au, Ag, Cu, Ni, Cr, Ge, Se, Ti, Sn, or oxides thereof.

11. The laminate material of claim 1, wherein the content of PE in the laminate material is greater than 90 wt % based on the total weight of the laminate material.

12. An article comprising the laminate material of claim 1.

13. A method for preparing the laminate material of claim 1, comprising
1) providing a first substrate comprising at least one metalized PE-based film and a second substrate comprising at least one PE-based film,
2) adhering the first substrate to the second substrate together by using a two-component solvent-based polyurethane adhesive composition;
wherein the concentration of fatty acids or fatty acid derivatives in the metalized PE-based film is less than 300 ppm, based on the total weight of the metalized PE-based film,
wherein the two-component solvent-based polyurethane adhesive composition comprises a polyester polyol component and a polyisocyanate component,
wherein the polyester polyol component has 40 wt %-60 wt % of aromatic rings in the backbone, based on the total weight of the polyester polyol and a Mw between 5,000 and 50,000; and
wherein the weight ratio of the polyester polyol component to the polyisocyanate component is from 100:5 to 100:30.
